(19) United States
(12) Patent Application Publication
(10) Pub. No.: US 2008/0099143 A1
(43) Pub. Date: May 1, 2008

(54) METHOD FOR RECLAIMING A LAYER OF PLASTIC MATERIAL FROM A LAMINATED SHEET

(75) Inventors: Mark Fretwurst, Galt (CA); Jeff McIntosh, Paris (CA)

Correspondence Address: BERESKIN AND PARR, 40 KING STREET WEST, BOX 401, TORONTO, ON, M5H 3Y2, US

(73) Assignee: PIXIU SOLUTIONS INC., Brantford (CA)

(21) Appl. No.: 11/552,579

(22) Filed: Oct. 25, 2006

(51) Int. Cl. B29C 63/00

(52) U.S. Cl. 156/344; 264/138; 156/584

(57) ABSTRACT

The invention is directed toward methods and apparatus for reclaiming a layer of plastic material from a laminated sheet. The method includes the steps of providing a laminated sheet comprising a first layer of plastic material and a second layer of substrate material bonded to the first layer along an interface plane, providing a cutting tool having a cutting edge extending in a parting plane, positioning the laminated sheet so that the parting plane is parallel to the interface plane and does not intersect the second layer, cutting the laminated sheet along the parting plane, directing a cut portion of the first layer away from a remaining portion of the laminated sheet, and collecting the cut portion of the first layer for reuse. The separating apparatus includes a feed roller for advancing the laminated sheet, a guide device for guiding the laminated sheet, and a hoop knife for cutting the laminated sheet. The method is particularly adapted for reclaiming a layer of polyvinyl chloride material from vinyl-foam laminates used in the automotive and roofing industries.

### FIELD OF THE INVENTION

The present invention relates generally to recycling methods, and in particular, to methods and apparatus for reclaiming a layer of plastic material, such as vinyl, from a laminated sheet.

### BACKGROUND OF THE INVENTION

As resources continue becoming scarce, greater emphasis is being put on sustainability, one aspect of which is recycling and reusing materials. One class of materials that is not regularly recycled or reused is laminated sheets. In particular, automotive manufacturers and suppliers use large quantities of vinyl laminated sheets for interior trim, seating, roofing, door paneling and other purposes. However, millions of pounds of scrap vinyl laminated sheets, are thrown away, instead of being recycled and reused.

Scrap vinyl laminated sheets can accumulate for a variety of reasons. Sometimes sheets arrive as seconds that are unusable in production. Trimming machines also produce leftover scrap when cutting out specific shapes from laminated sheets. First quality vinyl laminated sheets may also accumulate when a production vehicle becomes obsolete and the laminated sheets no longer serve a useful purpose in production. Regardless of how excess laminated sheets accumulate, recycling and reprocessing the material is more desirable than disposal.

Typically, vinyl laminated sheets are composed of layers of vinyl (i.e. polyvinyl chloride), foam, cloth and/or other materials. Each layer of material can be valuable in its independent form where it can be reused and resold for future applications. The vinyl layer is particularly valuable because the cost to produce vinyl from raw constituents is greater than the cost of purchasing vinyl in the form of scrap laminated sheets, even when considering some amount of reprocessing cost. Accordingly, it would be economically, as well as environmentally advantageous to recycle and reuse vinyl compounds found in laminated sheets. However, there is a need for an apparatus and method that can accurately separate layers for recycling.

There are only a few known methods of separating the layers of laminated sheets. One method employs chemical decomposition to remove the bond between laminated layers. In this manner, a solvent is applied to the surface of a laminated sheet. The solvent chemically reacts at the interface between layers to break down the interface bond and separate the two layers of material. Unfortunately, solvents often react with the material to be recycled and not just the interface bond, leaving the separated materials in an unusable or inferior condition.

Another method is a mechanical separation technique that involves freezing the laminated sheets with liquid nitrogen and fragmenting the sheets using a cutting process. A machine then pulverizes the frozen fragments to shear laminated layers from one another. Once separated, a cyclonic separator accumulates the recyclable material from the remaining scrap. Unfortunately, this mechanical method of separation has poor performance with respect to frictionally sliding layers apart, and also with cyclonically separating the small fragments of recycled material from the rest of the scrap.

Neither the chemical nor mechanical separation method produces a 100% clean, contaminate-free material at the end of the process. There is usually some fraction of an undesired layer of material in the final product. At best, current methods reach a 98% clean final product. However, this does not meet quality control standards for some industries, such as the automotive industry. Furthermore, the machinery and processes described above can be fairly complex, meaning higher capital costs and maintenance costs.

Accordingly, there remains a need for a method of reclaiming a layer of plastic material, such as vinyl, from laminated sheets to produce a final reclaimed material that is 100% clean. There is also a need for a relatively simple method of reclaiming a layer of plastic material from a laminated sheet.

### SUMMARY OF THE INVENTION

One aspect of the present invention is a method for reclaiming a layer of plastic material from a laminated sheet. The method comprises the steps of: providing a laminated sheet comprising a first layer of plastic material, and a second layer of substrate material bonded to the first layer along an interface plane, the substrate material having a different composition than the plastic material; providing a cutting tool having a cutting edge extending in a parting plane; positioning the laminated sheet so that the parting plane is parallel to the interface plane and does not intersect the second layer; cutting the laminated sheet along the parting plane so as to form a cut portion of the first layer and a remaining portion of the laminated sheet, the remaining portion comprising at least the second layer; and directing the cut portion of the first layer away from the remaining portion of the laminated sheet.

Another aspect of the invention is an apparatus for reclaiming a first layer of plastic material from a laminated sheet having a second layer of substrate material bonded to the first layer along an interface plane, the second layer having a different composition than the first layer. The apparatus comprises a feed roller rotatable about a rotational axis, the feed roller being configured to engage advance the laminated sheet along a longitudinal axis perpendicular to the rotational axis; a guide device laterally set apart from the feed roller, the guide device having an elongated shape extending along the rotational axis, the lateral distance between the guide device and the feed roller corresponding to the thickness of the laminated sheet; a hoop knife having a cutting edge that circulates continuously along a parting plane between the feed roller and the guide device; and means for positioning the cutting edge relative to the feed roller and the guide device such that the parting plane that is coplanar with or parallel to and offset from the interface plane such that the parting plane does not intersect the second layer.

### BRIEF DESCRIPTION OF THE DRAWINGS

The invention will now be described, by way of example only, with reference to the following drawings in which:

FIG. 1 is a perspective front view of a roll of laminated sheet;

FIG. 2 is a cross-sectional view of the laminated sheet along the section line 2-2 shown in FIG. 1;

FIG. 3 is a cross-sectional view of an alternative type of laminated sheet;

FIG. 4 is a flow chart depicting a method of reclaiming a layer of plastic material from a laminated sheet according to an embodiment of the present invention;

FIG. 5 is a schematic perspective view of a separating apparatus for reclaiming a layer of plastic material from a laminated sheet according to an embodiment of the present invention;

FIG. 6 is a cross-sectional view of a portion of the separating apparatus shown in FIG. 5 along a transverse plane;

FIG. 7 is a schematic cross-sectional view of the separating apparatus along a transverse plane, the separating apparatus including a top guide plate and control mechanisms configured to position elements of the separating apparatus;

FIG. 8 is a front sectional view of a portion of the separating apparatus shown in FIG. 7;

FIG. 9 is a flow chart depicting a method of setting the position elements of a separating apparatus according to an embodiment of the present invention; and

FIG. 10 is a cross-sectional view of a separating apparatus made in accordance with an alternative embodiment of the present invention.

### DETAILED DESCRIPTION OF THE INVENTION

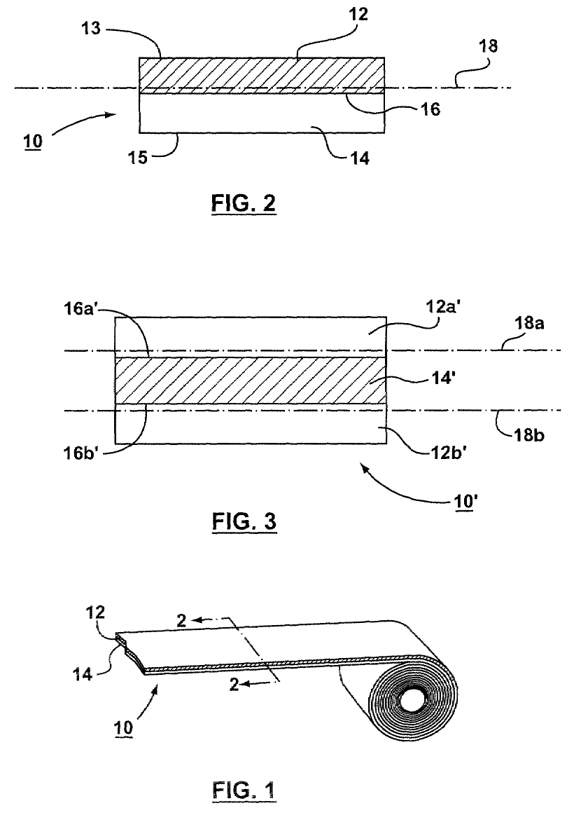

Referring to FIGS. 1 and 2, the present invention is directed to a method of reclaiming a layer of recyclable material, or more particularly, a layer of plastic material, from a laminated sheet 10. As shown in FIG. 1, the laminated sheet 10 may come in a roll. Laminated sheet 10 may also come as a sheet, a strip, a box of trimming scraps or another form suitable for reprocessing. Generally, laminated sheet 10 is a thin pliable material.

Referring to FIG. 2, illustrated therein is a cross-sectional view of the laminated sheet 10, which includes a first layer 12 bonded to a second layer 14 at an interface plane 16 using an adhesive, ultrasonic welding or another bonding means. First layer 12 has an exposed upper surface 13 and second layer 14 has an exposed bottom surface 15. The first layer 12 generally comprises the layer made of recyclable, or plastic material. The second layer 14 comprises a layer made of substrate material. If the recyclable material is to be reused or resold, the first layer 12 must be separated from the second layer 14 of substrate material.

Laminated sheet 10 may be a two-ply laminate, such as a vinyl-foam laminate wherein the first layer 12 can be made of a vinyl, such as polyvinyl chloride (PVC), or another vinyl compound. The second layer 14 can be made of a foam substrate. Vinyl-foam laminates have applications in the automotive industry, for example, interior trim, paneling and roofing. Vinyl-foam laminates in these applications typically have a thickness of approximately 1 mm-5 mm, with the vinyl layer having a thickness of approximately 0.5 mm-3 mm. The material construction and thickness of vinyl laminates make them fairly pliable so that they can easily form to cover various curved, or amorphous surfaces. It is possible that the method of the present invention may be applied to thicker or thinner materials, that may be more rigid, or more flexible than vinyl laminates.

Alternatively, laminated sheet 10 may be a two-ply laminate having a first layer 12 made of thermoplastic olefin (TPO) consisting of some fraction of polypropylene and polyethylene. The first layer 12 may also be made of other plastic materials. In additional embodiments, the second layer 14 may be made of a foam substrate, or another substrate material, such as a reinforcing fabric (i.e. scrim), cork, or rubber. The second layer 14 may also be composed of several substrate materials or layers of substrate materials.

Due to the thin, pliable nature of laminated sheets, such as vinyl-foam laminates, it was generally believed by professionals in the laminated sheet industry that it is impossible to cut and separate adjacent layers to reclaim specific layers for later reuse and recycling. Particularly, those skilled in the art did not believe that it is possible to cut and separate layers in a consistent way to provide 100% clean and uncontaminated final product. It was thought that the low melting point and high plasticity of materials such as vinyl would cause inaccuracies in the cutting process. It was also believed that blades and other cutting/positioning devices would become clogged with congealed material that has melted due to friction from the cutting operation. Accordingly, most vinyl-foam laminates are thrown away or used in manufacturing processes that require lower grades of vinyl.

However, the present inventors have found that layers of plastic, such as the vinyl found in vinyl-foam laminates, can be reclaimed from laminated sheets using the method of the present invention, which includes the step of separating the layer of vinyl along a parting plane 18, by example, using a cutting apparatus.

In some cases parting plane 18 may be coplanar with interface plane 16, however, in general, parting plane 18 is slightly offset from interface plane 16 and intersects the first layer 12. Positioning parting plane 18 parallel to interface plane 16, and through first layer 12 allows only a portion of the first layer to be removed from the laminated sheet. Removing only a portion of the first layer can yield a reclaimed portion that is 100% clean and free from contamination of the second layer after separation.

Referring to FIG. 3, laminated sheet could also be a three-layer laminated sheet 10′ having a top recyclable layer 12a′ bonded to a middle substrate layer 14′ at a top interface plane 16a′ and a bottom recyclable layer 12b′ bonded to the middle substrate layer 14′ at a bottom interface plane 16b′. An example of a three-layer laminated sheet 10′ is a roofing material, wherein the top recyclable layer 12a′ is made of high-quality vinyl, the middle substrate sheet 14′ is made of a durable reinforcing fabric, such as scrim, and the bottom recyclable layer 12b′ is made of low-quality vinyl. Both vinyl layers 12a′ and 12b′ in laminated sheet 10′ can be resold and reused if separated from substrate layer 14′ along parting planes 18a′ and 18b′ respectively.

For simplicity, the method of reclaiming a layer of recyclable material from laminated sheets will refer to laminated sheet 10. However, the method disclosed herewithin may also be effective when reclaiming layers from other laminated sheets such as laminated sheet 10′, and that other types of laminated sheets may also be processed using the method disclosed herewithin.

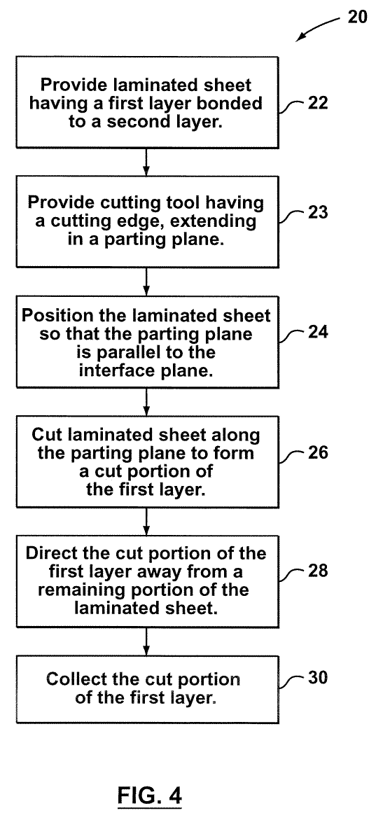

Referring now to FIG. 4, shown illustrated therein is a flow chart 20 depicting a method of reclaiming a layer of recyclable material from a laminated sheet according to a preferred embodiment of the invention. At step 22, there is provided a laminated sheet, such as laminated sheet 10, having a first layer 12 bonded to a second layer 14. At step 23, there is provided a cutting tool having a cutting edge extending in a parting plane 18. At step 24, the laminated sheet is positioned so that parting plane 18 is parallel to the interface plane 16 and does not intersect the second layer 14. At step 26, laminated sheet 10 is cut along parting plane 18. At step 28, a cut portion of the first layer 12 is directed away from a remaining portion of the laminated sheet. At step 30, the cut portion is collected for reuse.

In step 22, laminated sheet 10 may be provided as a roll, a sheet, a strip, a box of trimming scraps or another form suitable for reprocessing. Prior to positioning the separating apparatus, it may be necessary to reduce the width of the laminated sheet 10 to allow it to fit in the transverse extents of the separating apparatus.

In step 23, there is provided a cutting tool having a cutting edge extending along parting plane 18. Generally, cutting tool may be part of a separating apparatus that can cut and separate layers of the laminated sheet 18.

In positioning step 24, laminated sheet 10 is positioned so that the parting plane 18 is parallel to interface pan 16 and does not intersect second layer 14. Parting plane 18 should be either coplanar with interface plane 16 or parallel to and offset from interface plane 16 such that parting plane 18 intersects the first layer 12. In some cases, it may not be possible to maintain an entirely parallel relation between the parting plane and interface plane.

In cutting step 26, laminated sheet 10 is advanced relative to the separating apparatus. In this manner, laminated sheet 10 is cut along parting plane 18 to remove a cut portion of the first layer 12 from the laminated sheet. In some embodiments, only a portion of the first layer 12 may be removed from the laminated sheet depending on the location of parting plane 18 relative to interface plane 16. In other embodiments, it may be possible to entirely remove the first layer 12 from the laminated sheet.

In directing step 28, the cut portion of the first layer 12 is directed away from the remaining portion of the laminated sheet 10. A separation mechanism such as a wedge, spool or other device known in the art for separating two sheets or layers from each other may be used. If a wedge or ramp is used, the cut portion of the first layer 12 will be redirected away from the remaining portion of the laminated sheet 10.

At collecting step 30, the cut and separated portion of the first layer 12 is collected separately from second layer 14 and the remaining portion of laminated sheet 10. The cut and separated portion of the first layer 12 may then be resold or reused for future applications.

As mentioned above, if parting plane 18 intersects first layer 12, only a portion of the first layer 12 will be separated and collected. In this case, a portion of the first layer will be left attached to the remaining portion of laminated sheet 10. In such a case, the remaining portion of laminated sheet may be reprocessed one or more times to collect a greater amount of the first layer. Reprocessing should be completed in a similar manner as above to reduce the possibility of reclaiming portions of first layer 12 with second layer 14. In this manner, a 100% clean, uncontaminated recyclable material may be reclaimed.

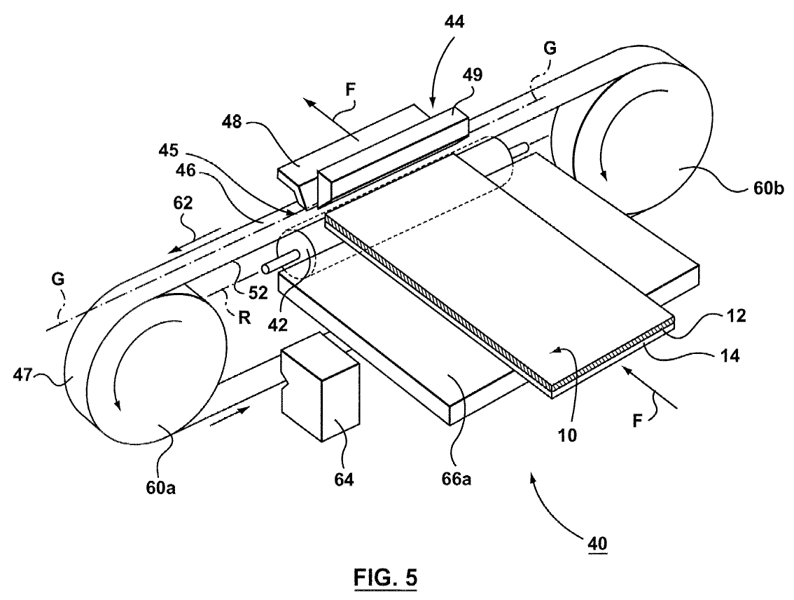

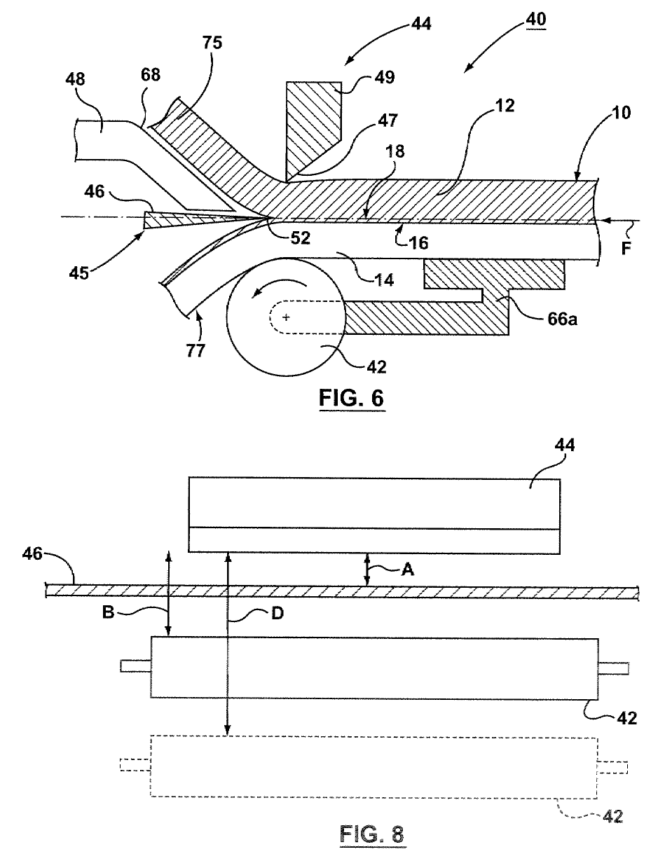

Referring now to FIGS. 5 and 6, illustrated therein is a schematic diagram of a separating apparatus 40 for implementing the method of the present invention. FIG. 5 is a perspective view of the separating apparatus, and FIG. 6 is a cross-sectional view of a portion of the separating apparatus along the feed direction, shown by the arrow 50. Separating apparatus 40 comprises a feed roller 42, a guide device 44, a cutting tool 45, and a knife guide gib 48.

Cutting tool 45 is preferably a hoop knife 46 that circulates continuously around two knife guide wheels 60a and 60b. The hoop knife 46 travels in a transverse direction 62, from knife guide wheel 60b, across laminated sheet 10, to knife guide wheel 60a and then back to knife guide wheel 60b. The transverse motion of hoop knife 46 allows cutting edge 52 to engage laminated sheet 10 at parting plane 18 and continuously shear a cut portion 75 of first layer 12 from the laminated sheet 10 while being advanced by feed roller 42. As hoop knife 46 circulates, a grinding stone 64 continuously sharpens the cutting edge 52, and oil applicators (not shown) provide lubrication and cleaning. Oil applicators may include, for example, sponges and cloths. There should be some degree of tension applied to hoop knife 46 by wheels 60a and 60b. Applying some tension improves cutting tolerances and to reduces the possibility of hoop knife 46 shifting on wheels 60a and 60b.

A knife guide gib 48 may be provided longitudinally downstream of cutting edge 52 to direct cut portion 75 of the first layer from the remaining portion 77 of laminated sheet 10. Knife guide gib 48 has a ramp-like top surface that spans the same transverse length as feed roller 42. After laminated sheet 10 is cut by hoop knife 46, knife guide gib 48 peels and diverts cut portion 75 of the first layer 12 away from remaining portion 77. As laminated sheet 10 advances along longitudinal feed axis F, cut portion 75 of the first layer slides up ramp 68 where it collects separately from the remaining portion 77. Knife guide gib 48 may have a special low friction coating to allow cut portion 75 to easily slide up ramp 68.

Feed roller 42 is located below, and slightly upstream of the cutting edge 52. The feed roller 42 is a long cylinder that rotates about a rotational axis R perpendicular to feed axis F, under the power of a motor (not shown). Rotational energy can be transmitted from the motor to the feed roller 42 by a series of shafts, bearings and joints. As mentioned above, feed roller 42 advances laminated sheet 10 into separating apparatus 40. Feed roller 42 generally has a textured or knurled surface that helps grab and pull laminated sheet 10 through separating apparatus 40.

Guide device 44 comprises an elongated body located directly above feed roller 42 on the opposite side of cutting edge 52, which extends along a guide axis G parallel to and offset from rotational axis R. Guide device 44 and feed roller 42 should be approximately the same length and should be separated by a distance correlated to the thickness of laminated sheet 10. Such distance is preferably equal to or slightly less than the thickness of laminated sheet 10. Both the guide device 44 and feed roller 42 should be made of resilient materials that do not deform easily, for example, steel or aluminum. The combination of feed roller 42 and guide device 44 help position and orientate the laminated sheet while being cut by hoop knife 46.

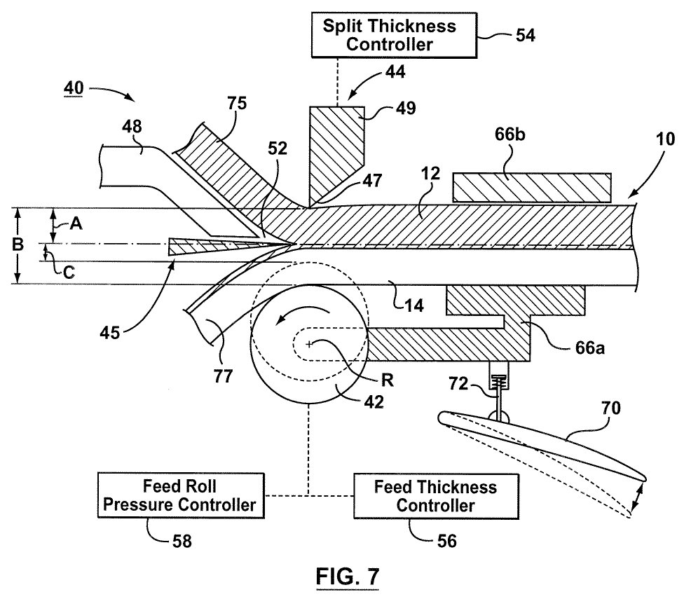

Referring now to FIGS. 7 and 8, the positioning of feed roller 42, guide device 44 and cutting tool 45 will be described in greater detail.

The position of guide device 44 relative to the feed roller 42 and cutting edge 52 set the location of parting plane 18 through laminated sheet 10. As shown in FIG. 7, the bottom most portion of guide device 44 is positioned a lateral distance “A” from cutting edge 52. Distance “A”, also known as a split thickness, generally corresponds to the thickness of first layer 12. A split thickness controller 54 connected to the guide device 44 allows for adjustment of the split thickness “A” by moving the guide device 44 up and down relative to the cutting edge 52. Connection of the split thickness controller 54 to guide device 44 is shown schematically as a dashed line, and may include gearing, shafts, electrical connections and other connection means. Split thickness controller 54 may include, an input, such as a crank or digital input, and an actuator, such as a rack and pinion, an adjusting screw, or a solenoid. By activating the input to set the desired split thickness “A”, the actuator will move the guide device 44 to a position corresponding to the split thickness “A”.

In order for the laminated sheet 10 to pass through separating apparatus 40, the overall thickness of laminated sheet 10 must fit through a second distance “B” that extends laterally between the topmost portion of feed roller 42 and the bottom most portion of guide device 44. Distance “B” generally corresponds to the thickness of laminated sheet 10. However, distance “B” may be slightly smaller than the thickness of laminated sheet 10, thereby applying some degree of feed roll pressure.

Advancing laminated sheet 10 through the separating apparatus 40 against the back pressure of the hoop knife may require varying amounts of advancing force. The easiest way to vary the advancing force is to change the frictional force applied by the feed roller 42 by changing the feed roller pressure. Feed roll pressure is applied by narrowing the distance between feed roller 42 and guide device 44 such that distance “B” is smaller than the thickness of laminated sheet 10. The amount of feed roll pressure may depend on, for example the thickness, stiffness, compressibility and surface friction of laminated sheet 10. In addition, the type of surface coating or texture applied to the circumferential portion of the feed roller may affect the required amount of feed roll pressure. For thicker and stiffer materials, more feed roll pressure may be necessary than with thinner more pliable materials.

To set distance “B”, an operator first sets a feed thickness that corresponds to the thickness of laminated sheet 10, and then sets the feed roll pressure. Generally, the feed thickness is slightly less than the thickness of the laminated sheet and sets a buffer thickness for the application of feed roll pressure. The feed thickness is adjustable, for example, using a feed thickness controller that connects to feed roller 42 (the connection shown schematically as a dashed line). The components of feed thickness controller 56 and connection details may be similar those described with respect to split thickness controller 54.

Referring to FIG. 7, the feed thickness should incorporate a minimum separation “C” between cutting edge 52 and feed roller 42 to reduce the possibility of hoop knife 46 rubbing against feed roller 42. The minimum separation “C” should generally be at least 0.1 mm, and is adjustable using, for example, set screws.

Feed roll pressure is adjustable separately from feed thickness using a feed roll pressure controller 58 that connects to the feed roller 42 (the connection shown schematically as a dashed line). Feed roll pressure controller 58 may include, for example, an input device, such as a crank or a digital input, and an actuator, such as a hydraulic cylinder or a spring mechanism. The actuator of the feed roll pressure controller is generally coupled to a portion of the feed thickness controller to allow the application of varying amounts of feed roll pressure.

A benefit of setting feed roll pressure independent of feed thickness is that distance “B” can expand beyond the feed thickness while maintaining constant feed roll pressure, or vice versa. When applying feed roll pressure, a small degree of material compression may occur as laminated sheet 10 passes between feed roller 42 and guide device 44 (shown exaggerated in FIG. 6). The two-part control system allows adjustment of distance “B”, including setting feed thickness and feed roll pressure, to process materials having non-uniform cross-section, or variable compressibility. For example, a small bump in the laminated sheet 10 may over-compress the laminated sheet 10 and change the feed geometry to position the parting plane through a portion of second layer 14, or the bump may cause the feed roll motor to stall With a two-part control system, the bump momentarily increases distance “B” by shifting feed roller 42 downward beyond the feed thickness while maintaining feed roll pressure. Expansion of distance “B” allows laminated sheet 10 to pass through separating apparatus 40 in a generally continuous fashion without deforming the sheet material (which may have lead to reclaiming a portion of the second layer with the first layer), or stalling the feed roll motor. In the opposite scenario, where laminated sheet 10 has thinner sections, distance “B” can shrink to the feed thickness with a corresponding drop in feed roll pressure. This shrinking reduces the chance of over-compression of laminated sheet 10, which may otherwise lead to the inclusion of portions of second layer 14 with first layer 12 after processing. In both scenarios described above, separating apparatus 40 maintains reasonable accuracy with respect to feed geometry and cutting tolerances.

As shown in FIGS. 5 and 6, guide device 44 comprises an elongated a guide bar 49 having a beveled edge 47 facing upstream to help guide laminated sheet 10 into cutting edge 52. Beveled edge 47 helps laminated sheet 10 gradually compress under feed roll pressure. In general, guide bar 49 should be used when cutting thin and pliable materials. When cutting thicker and stiffer materials, the guide bar may be replaced with an upper guide roller to provide larger advancing forces that are needed to pass stiffer laminated sheets through the compression.

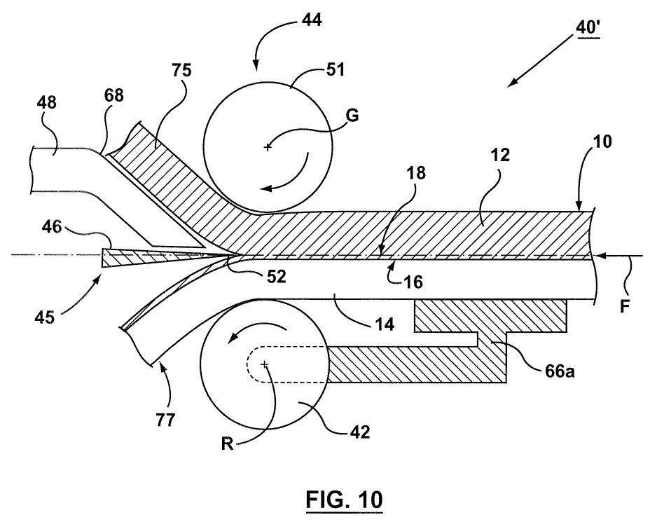

Referring now to FIG. 10, illustrated therein is separating apparatus 40′ made in accordance with an alternative embodiment of the invention, in which the guide device 44 comprises guide roller 51 that rotates about guide axis G. Guide roller 51 is similar to feed roller 42, and is preferably powered by the motor (not shown) that powers feed roller 42. As shown, the motor should be connected to guide roller 51 such that the guide roller 51 and feed roller 42 are counter rotating. Guide roller 51 may be connected to the motor using a series of shafts, bearings and joints. Since both the feed roller 42 and guide roller 51 provide advancing force thicker and stiffer materials may be fed through separating apparatus 40.

In general, when separating apparatus 40′ employs a guide roller 51, cutting tolerances are lower than when using a guide bar 44 as shown in FIGS. 5 and 6. For example, possible variations in speed and applied force between the guide roller 51 and feed roller 42 may cause buckling of the laminated sheet 10. Determining the type of guide device for a particular application can depend on the type of feed material, desired cutting tolerances, and other factors.

When inserting laminated sheet 10 into separating apparatus 40, the laminated sheet 10 should be orientated such that first layer 12 is adjacent to guide device 44 and second layer 14 is adjacent to feed roller 42. This orientation can provide fairly accurate cutting and separation of the first layer 12 from laminated sheet 10. Accurate cutting is achieved because split thickness “A” is constant, unlike distance “B” which is variable. As long as split thickness “A” is set to the minimum cross-sectional thickness of first layer 12, any variations in thickness of laminated sheet 10 will result in the excess portions of the first layer being left on the remaining portion of the laminated sheet. This means the reclaimed cut portion 75 of the first layer should remain 100% clean and uncontaminated by the second layer. Conversely, if the first layer 12 is adjacent to the feed roller 42, any accidental lateral motion of feed roller 42 may result in momentary dips across the interface plane 16, resulting in the removal of a portion of the second layer 14 with cut portion 75 of the first layer 12.

As shown in FIGS. 5 and 6, separating apparatus 40 can also include a bottom guide plate 66a that has a flat surface shaped to support laminated sheet 10 while being pulled forward by feed roller 42. As shown, bottom guide plate 66a can connect to feed roller 42 such that any lateral movements are experienced by both bottom guide plate 66a and feed roller 42. For example, when adjusting feed thickness both feed roller 42 and bottom guide plate 66a will move the same lateral distance.

Referring again to FIG. 7, separating apparatus 40 may also include a top guide plate 66b positioned laterally above bottom guide plate 66a, on the opposite side of the laminated sheet. Top guide plate 66b helps orient laminated sheet 10 and reduces the chance of buckling while passing through the separating apparatus Both guide plates 66a and 66b are placed longitudinally upstream of feed roller 42 and extend transversely to the extents of feed roller 42.

Referring to FIGS. 7 and 8, separating apparatus 40 may include a foot pedal 70 in connection with the feed roller 42. When inserting laminated sheet 10 into separating apparatus 40, depressing foot pedal 70 creates a gap “D” between feed roller 42 and guide device 44. Gap “D” is larger than distance “B” and allows the leading edge of laminated sheet 10 to be easily inserted into separating apparatus 40 and clutched between feed roller 42 and guide device 44. Foot pedal 70 can be connected to both feed roller 42 and bottom guide plate 66a through, for example a hydraulic cylinder 72, or another spring-return linkage. Upon releasing foot pedal 70, hydraulic cylinder 72 forces feed roller 42 and bottom plate 66a back into position to maintain distance “B” and reapply feed roll pressure. In some embodiments, foot pedal 70 may be connected only to the feed roller 42 or bottom guide plate 66a.

The operation of the separating apparatus 40 will now be described in greater detail. Initially, laminated sheet 10 is provided and positioned on the bottom guide plate 66a. The foot pedal 70 is depressed to open the distance between the feed roller 42 and the guide device 44. An operator then advances the laminated sheet 10 into the opening between the feed roller 42 and guide device 44. Foot pedal 70 is then released, thereby closing the opening between the feed roller 42 and guide device 44 to apply a predetermined amount of feed roller pressure. As feed roll pressure is applied, the rotation of the feed roller 42 pulls the laminated sheet 10 toward the circulating hoop knife 46. The cutting edge 52 of the hoop knife 46 contacts the laminated sheet 10 and begins shearing the first layer 12 along the parting plane 18. Cut portion 75 of the first layer then slides up the knife guide gib 48, such that the cut portion 75 redirects away from the remaining portion 77 of the laminated sheet which collects below the hoop knife 46. The cut portion 75 of the first layer can then be collected for resale or reuse in future applications.

The first layer 12 is preferably sheared from laminated sheet 10 just above interface plane 16 so as to produce a 100% clean and uncontaminated cut portion 75 of the first layer 12 after processing. This creates remaining portion 77, which typically comprises second layer 14 and a small amount of first layer 12 attached to second layer 14 after cutting, as shown in FIG. 6. In this case, the remaining portion 77 that collects below the hoop knife 46 as scrap may be reprocessed one or more times in the separating apparatus to reclaim greater portions of the first layer. Alternatively, the remaining portion 77 may be treated as scrap and thrown away, or recycled in some other manner. In some embodiments of the present invention, separating apparatus 40 can be setup such that split thickness “A” and feed thickness are sufficient to ensure no portion of second layer 14 passes across knife guide gib 48, while leaving as little as possible of first layer 12 bonded to the remaining portion of laminated sheet 10.

According to some embodiments of the present invention, laminated sheet 10 should be positioned such that exposed bottom surface 15 of second layer 14 (the surface opposite to the interface plane) is flat and parallel to the interface plane 16 to help provide a 100% clean reclaimed material. If bottom surface 15 and interface plane 16 are parallel, there is a lower chance that fluctuations in material thickness will lead to cut portions of first layer 12 that include portions of second layer 14.

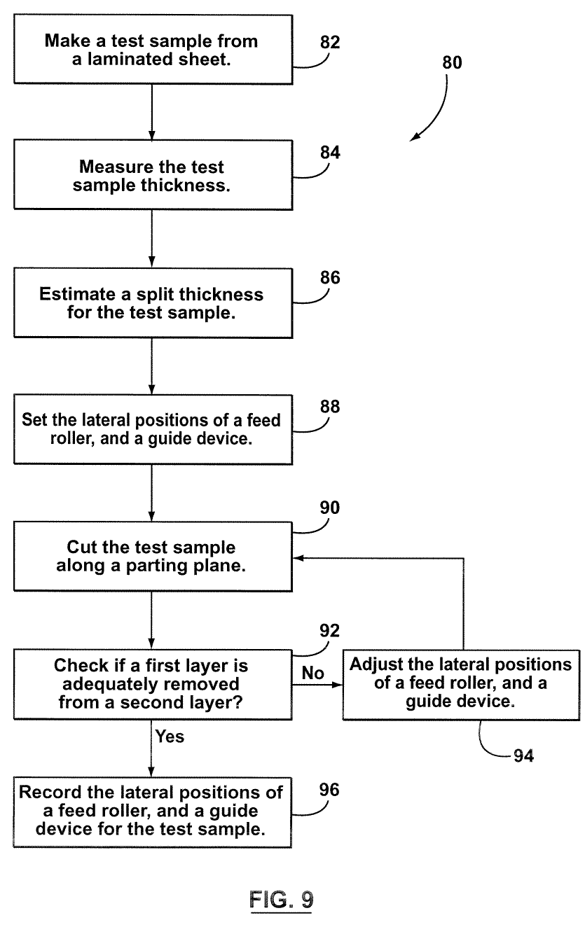

Referring now to FIG. 9, shown therein is a flow chart 80 depicting a method of determining the split thickness “A”, feed thickness, and feed roll pressure for a particular combination of a separating apparatus 40 and a laminated sheet 10. The method includes sample making step 82, in which a test sample is made, measuring step 84, in which the test sample thickness is measured, estimating step 86, in which a split thickness is estimated, setting step 88, in which the feed roller and guide device are set to define a parting plane 88, cutting step 90, in which the test sample is cut along the parting plane to form a cut portion, checking step 92, in which the cut portion is checked for adequate removal. The method may also include adjusting step 94, in which the positions of the feed roller are adjusted, and recording step 96, in which the lateral position of the guide device, feed roller are recorded.

At step 82, a test sample is cut from a laminated sheet 10. The test sample should be of a size that quickly and easily passes through separating apparatus 40 in order to reduce set up time. A test sample of size 100 mm wide×200 mm long is suggested for separating apparatuses having feed rollers of approximately 50 mm diameter and 1000 mm length.

At step 84, the thickness of the test sample is measured to determine the feed thickness. Determination of the feed thickness should incorporate adequate feed roll pressure depending on the type of laminated sheet 10. For samples approximately 2 mm thick, a good initial estimate for the feed thickness is 5% less than the sample thickness. In some cases, the feed thickness may be set to the minimum separation “C” and the distance “B” may be controlled entirely by feed roll pressure.

At step 86, the thickness of first layer 12 is estimated to determine a split thickness “A”. The split thickness “A” may be estimated by taking the measured sample thickness and multiplying it by an estimation of the ratio of the thickness of first layer 12 compared to the overall test sample thickness.

At step 88, feed roller 42 and guide device 44 are positioned according to the split thickness “A” and feed thickness. The feed roll pressure can also be set at the same time.

At step 90, the test sample is fed through separating apparatus 40 to cut laminated sheet 10 along a parting plane corresponding to the split thickness, the feed thickness, and the feed roll pressure. A cut portion of the first layer 12 collects beyond knife guide gib 48 and the remaining portion of laminated sheet collects below hoop knife 46 as a remaining portion of laminated sheet 10.

At step 92, an operator checks the cut portion to see if first layer 12 has been completely removed from second layer 14 while having an acceptable amount of first layer 12 left on the remaining portion of the laminated sheet If first layer 12 is entirely removed the from second layer 14, but there is still a substantial amount of first layer 12 remaining on the scrap portion, the split thickness “A” may be too small. Conversely, if first layer 12 is not completely removed from second layer 14 (i.e. the cut portion includes some of the second layer), then the split thickness “A” may be too large.

At step 94, the split thickness “A” is adjusted according to the results of step 92 and the parting plane is repositioned accordingly. When adjusting the split thickness “A”, corresponding adjustments should be made to the both the feed roller position and the guide device position so as to maintain the feed thickness. In addition, the feed roll pressure and feed thickness may be adjusted separately if there were problems with advancing the test sample through separating apparatus 40.

Steps 90, 92 and 94 are repeated until first layer 12 is completely removed from second layer 14 and there is an acceptable amount of first layer 12 remaining on the scrap portion. When repeating step 90, a new test sample may be used, or the same test sample may be reused.

At step 96, the split thickness, feed thickness and feed roll pressure are recorded and associated with the test sample. The positions of the feed roller 42 and guide device 44, and the feed roll pressure may be catalogued so future production runs involving the same laminated sheet 10 can be set up without performing the method shown at 80.

The method of the present invention can be applied to laminated sheet 10′, shown in FIG. 3. The method involves setting up separating apparatus 40 to remove the top recyclable layer 12a′ from the middle substrate layer 14′ and bottom recyclable layer 12b′ by cutting laminated sheet 10′ along parting plane 18a′. After cutting along parting plane 18a′, the top recyclable layer 12a′ can be separated and collected for reuse. In addition, the remaining portion of laminated sheet 10′, including the middle substrate layer 14′ and the bottom recyclable layer 12b′, can be reprocessed to reclaim the bottom recyclable layer 12b′. Accordingly, the remaining portion of laminated sheet 10′ is flipped over and separating apparatus 40 is positioned to remove the bottom recyclable layer 12b′ from the middle substrate layer 14′ by cutting laminated sheet 10′ along parting plane 18b′. After cutting along parting plane 18b′, the bottom recyclable layer 12b′ can be separated and collected for reuse.

The method described above allows reclaiming of two recyclable layers such that each layer is 100% clean, and uncontaminated with respect to the middle substrate 14′. In additional embodiments, other variations on the methods described herein may be applied to other laminated sheets having different permutations of recyclable and substrate layers.

By using the method of the present invention it is possible to reclaim a layer of material from a laminated sheet, such that the layer may then be recycled or reused. In particular, it is possible to purchase scrap vinyl laminate, reclaim the vinyl from the scrap and resell the vinyl for a profit. According to an embodiment of the present invention, it is possible to produce a 100% clean, contaminate free recyclable layer from a laminated sheet. According to another embodiment of the present invention, it is possible to reclaim a recyclable layer from a laminated sheet in a simple, reliable fashion.

Although the method for reclaiming a recyclable layer from a laminated sheet has been described with reference to preferred embodiments, it should be apparent that alternative embodiments involving different separating apparatus, and different laminated sheets are possible.

It should therefore be apparent to one skilled in the art that various modifications can be made to the embodiments disclosed herein, without departing from the present invention, the scope of which is defined in the appended claims.

1. A method for reclaiming a layer of plastic material from a laminated sheet, comprising the steps of:
a) providing a laminated sheet comprising a first layer of plastic material, and a second layer of substrate material bonded to the first layer along an interface plane, the substrate material having a different composition than the plastic material;
b) providing a cutting tool having a cutting edge extending in a parting plane;
c) positioning the laminated sheet so that the parting plane is parallel to the interface plane and does not intersect the second layer;
d) cutting the laminated sheet along the parting plane so as to form a cut portion of the first layer and a remaining portion of the laminated sheet, the remaining portion comprising at least the second layer; and
e) directing the cut portion of the first layer away from the remaining portion of the laminated sheet.

2. The method of claim 1, further comprising the step of collecting the cut portion of the first layer.

3. The method of claim 1, wherein the laminated sheet is positioned so that the parting plane intersects the first layer.

4. The method of claim 1, wherein the cutting step is performed by advancing the laminated sheet into the cutting tool.

5. The method of claim 4, wherein the advancing is performed by a feed roller configured to advance the laminated sheet along a longitudinal axis into the cutting tool, wherein the feed roller is rotatable about a rotational axis perpendicular to the longitudinal axis.

6. The method of claim 7, wherein the positioning step is performed by adjusting a guide device for guiding the laminated sheet, the guide device having an elongated body extending along an axis parallel to and offset from the rotational axis by a lateral distance, the lateral distance being correlated with the thickness of the laminated sheet.

7. The method of claim 6, where the cutting tool comprises a hoop knife and the cutting edge circulates continuously along the parting plane between the feed roller and the guide device.

8. The method of claim 7, wherein the laminated sheet is positioned so that the second layer is adjacent to the feed roller and the first layer is adjacent to the guide device.

9. The method of claim 8, wherein the directing step is performed by a knife guide gib downstream of the cutting edge.

10. The method of claim 6, wherein the positioning step is facilitated by a bottom guide plate upstream of the feed roller shaped to support the laminated sheet in a horizontal plane.

11. The method of claim 1, wherein the positioning step comprises the steps of:
a) making a test sample from the laminated sheet;
b) measuring a feed thickness of the test sample corresponding to the thickness of the test sample;
c) estimating a split thickness of the test sample corresponding to the first thickness;
d) setting lateral positions of the feed roller and the guide device corresponding to the split thickness and the feed thickness to define the parting plane;
e) cutting the test sample along the parting plane to form a cut portion of the first layer and a remaining portion of the test sample; and
f) checking that the cut portion of the first layer excludes a portion of the second layer, and checking that an acceptable amount of the first layer remains on the remaining portion of the test sample.

12. The method of claim 11, further comprising the step of recording the lateral positions of the feed roller and the guide device and associating the lateral positions with the test sample.

13. The method of claim 12, wherein if the cut portion of the first layer includes a portion of the second layer, or if an unacceptable amount of the first layer remains on the remaining portion of the test sample after the step of checking, the method further comprising the steps of:
a) adjusting the lateral positions of the feed roller and the guide device to define a new location of the parting plane; and
b) repeating the step of cutting, and the step of checking, with the test sample or a new test sample made from the laminated sheet.

14. The method of claim 1, wherein the plastic material is a vinyl material.

15. The method of claim 1, wherein the vinyl material is polyvinyl chloride.

16. The method of claim 1, wherein the laminated sheet is a vinyl laminated sheet having a thickness of between 1 mm and 5 mm, and first layer is a layer of vinyl material having a thickness of between 0.5 mm and 3 mm.

17. A method of reclaiming a layer of vinyl from a vinyl laminate, the method comprising the steps of:
a) providing a vinyl laminate comprising a first layer of vinyl and a second layer of substrate material bonded to the first layer along an interface plane, the second layer having a different composition than the first layer;
b) positioning the vinyl laminate so that the interface plane is parallel to a parting plane, the parting plane being offset from the interface plane by a predetermined distance within the range of 0 to 0.5 mm, such that the parting plane intersects the first layer;
c) cutting the vinyl laminate along the parting plane so as to form a cut portion of the first layer and a remaining portion of the vinyl laminate; and
d) directing the cut portion of the first layer away from the remaining portion of the vinyl laminate.

18. The method of claim 17, wherein the cutting step is performed by advancing the vinyl laminate into a separating apparatus comprising:
a) a feed roller rotatable about a rotational axis, the feed roller being configured to advance the vinyl laminate along a longitudinal axis perpendicular to the rotational axis;
b) a guide device laterally set apart from the feed roller, the guide device having an elongated body extending along a guide axis parallel to and offset from the rotational axis; and
c) a hoop knife having a cutting edge that circulates continuously along the rotational axis between the feed roller and the guide device, the parting plane being defined by position of the cutting edge relative to the feed roller and the guide device.

19. Apparatus for reclaiming a first layer of plastic material from a laminated sheet having a second layer of substrate material bonded to the first layer along an interface plane, the second layer having a different composition than the first layer, the apparatus comprising:
a) a feed roller rotatable about a rotational axis, the feed roller being configured to engage advance the laminated sheet along a longitudinal axis perpendicular to the rotational axis;
b) a guide device laterally set apart from the feed roller, the guide device having an elongated body extending along a guide axis parallel to and offset from the rotational axis, the guide device cooperating with the feed roller to guide the laminated sheet;
c) a hoop knife having a cutting edge that circulates continuously along a parting plane between the feed roller and the guide device; and
d) means for positioning the cutting edge relative to the feed roller and the guide device such that the parting plane is either coplanar with the interface plane, or parallel with and offset from the interface plane, so as to not intersect the second layer.

20. The separating apparatus of claim 19, further comprising a knife guide gib downstream of the cutting edge.
